(19) United States
(12) Patent Application Publication
(10) Pub. No.: US 2008/0175513 A1
(43) Pub. Date: Jul. 24, 2008

(54) Image Edge Detection Systems and Methods

(76) Inventors: Ming-Jun Lai, Watkinsville, GA (US); Kyunglim Nam, Waco, TX (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/911,748

(22) PCT Filed: Mar. 31, 2006
(86) PCT No.: PCT/US06/11841

§ 371 Date: Oct. 17, 2007

Related U.S. Application Data
(60) Provisional application No. 60/672,759, filed on Apr. 19, 2005.

(51) Int. Cl. G06K 9/40

(52) U.S. Cl. 382/267

(57) ABSTRACT

Various embodiments of edge detection systems and methods are disclosed. One method embodiment, among others, comprises receiving an image (602), applying a box-spline based tight wavelet frame to the image to decompose the image into low pass and high pass portions (604), and reconstructing the image from the high pass portions to yield edges of the image (606).

### CROSS-REFERENCE TO RELATED APPLICATION

This application claims priority to copending U.S. provisional application entitled, “IMAGE EDGE DETECTION SYSTEMS AND METHODS,” having Ser. No. 60/672,759, filed Apr. 19, 2005, which is entirely incorporated herein by reference.

### STATEMENT REGARDING FEDERALLY SPONSORED RESEARCH OR DEVELOPMENT

The U.S. government has a paid-up license in this invention and the right in limited circumstances to require the patent owner to license others on reasonable terms as provided for by the terms of EAR0327577 awarded by the National Science Foundation of the U.S.

### TECHNICAL FIELD

The present disclosure is generally related to image processing technology, and, more particularly, is related to systems and methods of edge detection in image processing systems.

### BACKGROUND

Image processing systems are used in a wide variety of fields. For example, in medical imaging, image processing systems are used to detect masses, organ and circulatory abnormalities, among other irregularities. In video and camera systems, image processing systems can enhance picture quality by filtering out noise and other artifacts. One particular aspect of image processing that has experienced incredible growth, such as in the area of pattern recognition, is image edge detection. Edge detection is a basic step in image analysis.

When implementing image analysis, various information about an image 100 is typically desired. For example, with reference to FIG. 1, an image of an F-16 fighter jet is shown. Clearly, an F-16 fighter jet and the letters F-16 and U.S. AIR FORCE and many symbols from the image 100 can be seen by a causal observer.

However, for many applications, such as pattern recognition and computer vision, a computer is used to recognize the fighter jet and other details associated with the image 100. In one implementation, the image 100 is decomposed into many basic lines or curved boundaries called edges. The edges in an image separate the areas of the image with different intensity contrasts (e.g., incremental increases and decreases in intensity from one pixel to the next). The computer then compares the line or curve boundaries with existing known objects, such as symbols (e.g., letters) and/or patterns, so that some patterns from an image can be recognized.

Many edge detection methods are disclosed in the literature and commercially available. In general, there are two basic categories of image edge detection methods. One category is often referred to as classic engineering edge detection methods. Among them are the Canny, Laplace, Prewitt, Roberts, Sobel, and zero-crossing methods which are available commercially (e.g., via MATLAB Signal and Image Toolbox produced by The MATHWORKS, Inc.). These methods have been studied for improvement for many years. Results obtained by using Canny and Sobel methods for detecting the edges of an image (e.g., the F-16 fighter jet) are shown in FIGS. 2A and 2B, respectively. These and other classic engineering edge detection methods can further be categorized as either gradient techniques or Laplacian edge detection techniques. The Laplacian techniques generally search for zero-crossings in the second derivative of an image to find edges.

The gradient method detects edges by determining the maximum and minimum in the first derivative of an image, generally through the use of filters. There are several well-known gradient filters. For example, Sobel gradients are obtained by convolving an image with kernels. Each kernel computes the gradient in a specific direction and later these partial results are combined to produce the final result. Each partial result computes an approximation to the true gradient by either using Euclidean distances or absolute differences. For instance, the gradient magnitude may be computed by summing the absolute values of the gradients in X (width) and in Y (height) directions. Variations can be obtained by rotating the kernel values.

Another gradient method includes the Canny method. In general, a Canny edge detector smoothes the image to eliminate the noise, then finds the image gradient to highlight regions with high spatial derivatives. An algorithm then tracks along these regions and suppresses any pixel that is not at the maximum. The gradient array is further reduced by tracking along the remaining pixels that have not been suppressed. If the magnitude is below a first threshold, it is set to zero (i.e., made a non-edge). If the magnitude is above a second threshold, it is made an edge. If the magnitude is between the two thresholds, then the pixel magnitude is set to zero unless there is a path from the corresponding pixel to a pixel with a gradient above the second threshold. Other well-known gradient kernals are known, including Roberts and Prewitt gradient kernels.

Although these various techniques generally provide for enhanced images, there remains a need to improve image quality in all areas of image processing. For instance, one problem with the Canny and Sobel methods is that many important features may be lost.

Another category of edge detection methods is often referred to as the wavelet methods. Wavelet methods for edge detection are relatively new and are often the subject of research in mathematical sciences, computer science, and electric engineering. FIGS. 3A and 3B provide an illustrative view of edges detected using Daubechies wavelets and biorthogonal 9/7 wavelets, respectively. These and other wavelet methods are generally based on the so-called scaling functions and wavelet functions, which are used to decompose an image into a low-pass part by a scaling function and several high-pass parts by using its associated wavelet functions. By setting the low-pass part to zero, one reconstructs the image from the high-pass parts only. The reconstructed image shows only the edges of the image.

The mathematical theory used as a basis for wavelet methods relies on the fact that when an image is represented by using scaling and wavelet functions, the rapid changes in image pixel intensity contrasts are manifested among the coefficients associated with high-pass parts. The coefficients associated with low-pass parts represent the smooth part of images. Although straightforward in theory, finding a good wavelet function to clearly detect edges is not easy. Although there are many wavelet functions available in the literature, it appears that none of the wavelet methods for edge detection performs better than the classic edge detection methods.

### SUMMARY

Embodiments of the present disclosure provide systems and methods for image edge detection. Briefly described, in architecture, one embodiment of the system, among others, comprises memory with image edge detection software, a processor configured with the image edge detection software to receive an image, apply a box-spline based tight wavelet frame to the image to decompose the image into low pass and high pass portions, and reconstruct the image from the high pass portions to yield edges of the image.

Embodiments of the present disclosure can also be viewed as providing image edge detection methods. In this regard, one embodiment of such a method, among others, comprises receiving an image, applying a box-spline based tight wavelet frame to the image to decompose the image into low pass and high pass portions, and reconstructing the image from the high pass portions to yield edges of the image.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a photo of an exemplary image.

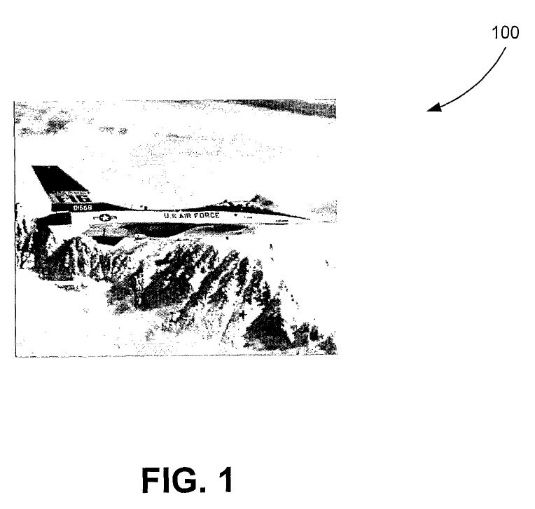

FIGS. 2A-2B are exemplary edge detection images of the image shown in FIG. 1 produced using classic engineering edge detection methods.

FIGS. 3A-3B are exemplary edge detection images of the image shown in FIG. 1 produced using conventional wavelet methods.

FIG. 4 is an exemplary edge detection image of the image shown in FIG. 1 produced using an embodiment of an image edge detection system and method.

FIG. 5 is a block diagram of one embodiment of an edge detection system.

FIG. 6 is a flow diagram of one embodiment of an edge detection method.

### DETAILED DESCRIPTION

Disclosed are various embodiments of image edge detection systems and methods. Such image edge detection systems and methods comprise a combination of functions that are used to detect edges in images. In particular, embodiments of the image edge detection systems and methods comprise a combination of box-spline functions with tight wavelet frame functions.

Embodiments of the image edge detection methods can be generally classified under the wavelet methods. However, instead of a wavelet function, the disclosed embodiments use a tight wavelet frame based on a box-spline function to detect edges and extract features from images. A spline is generally understood by those having ordinary skill in the art as referring to a “piecewise” polynomial function with certain smoothness. A box-spline is generally understood by those having ordinary skill in the art as referring to a spline function which is defined by using a convolution of box functions. For example, B₁₁ is a function that has value 1 inside [0,1]×[0,1] and zero outside of [0,1]×[0,1]. A wavelet is generally understood by those having ordinary skill in the art as referring to a collection of functions that are obtained from integer translates and dilates of one or a few generating functions such that the collection forms an orthonormal basis for the space of all images of finite energy. One having ordinary skill in the art would understand that integer translates of a function f(x,y) comprise f(x−m,y−n) for integers m and n. That is, a function is shifted by integers. Further, one having ordinary skill in the art would understand that dilates of a function f(x,y) are f(2^{m}x,2ⁿy) for all integer m, n. That is, a dilate of a function is a scaled version of the function.

A tight wavelet frame is generally understood by those having ordinary skill in the art as referring to a collection of integer translates and dilates of one or a few functions, which (the collection) forms a redundant basis for images of finite energy in the sense that any image of finite energy can be expanded in terms of functions in the collection, and the sum of the squares of coefficients in the expansion is the same as the square of the energy of the image. Generally, tight wavelet frame functions are more flexible than wavelet functions.

In particular, the disclosed image edge detection systems and methods use one or more box-spline functions and several framelets (each of the generating functions corresponding to frames is called a framelet, and a tight wavelet frame usually comprises several framelets) to decompose images into a low-pass part and several high-pass parts. The edges are computed by reconstructing the image from high-pass parts only. The tight wavelet frame may be constructed based on a box-spline on a four-direction mesh (e.g., triangulation), or other direction (e.g., six, eight, etc.) meshes in some embodiments.

In the description that follows, an exemplary tight wavelet frame is derived based on one well-known box-spline B₂₂₁₁ (see, for e.g., “Box-splines,” by de Boor, Hollig and Riememschneider, 1993 which describes box-splines), followed by a description corresponding to the illustrated results of implementing such a tight wavelet frame. Following the description, one embodiment of an image edge detection system is described, followed by a method embodiment that may be implemented in the system.

Although the preferred embodiments of an image edge detection system and method are described herein based on a single, bivariate box-spline, B₂₂₁₁, it would be understood by one having ordinary skill in the art that a tight wavelet frame can be generated based on other box-splines or box-spline types in a manner similar to the methodology described herein. Further, although one tight wavelet frame is demonstrated, the same or similar methodology described herein can be used to derive other tight wavelet frames and thus the scope of the preferred embodiments include such other tight wavelet frames.

Beginning with a derivation of an exemplary tight wavelet frame, a mathematical definition of tight wavelet frames based on a multi-resolution approximation of L₂(R²) can be provided, where L₂(R²) is generally understood by those having ordinary skill in the art as referring to the space of all images of finite energy. Given a function ψεL₂(R²), the following equation is known:

ψ_{j,k}(y)=2^{j}ψ(2^{j}y−k). (Eq. 1)

Let Ψ be a finite subset of L₂(R²) and

Λ(Ψ):={ψ_{j,k},ψεΨ,jεZ,kεZ²}. (Eq. 2)

Considering equations (1) and (2) above, one definition of frames can be provided that states that Λ(Ψ) is a frame if there exist two positive numbers A and B such that the following equation is valid:

$$A {‖ f ‖}_{{L}_{2} ( {ℛ}^{2} )}^{2} \leq {\sum }_{g ∈ Λ ( Ψ )}^{ } {\vert 〈 f , g 〉 \vert}^{2} \leq B {‖ f ‖}_{{L}_{2} ( {ℛ}^{2} )}^{2} \qquad ( Eq . 3 )$$

for all fεL₂(R²).

Further, another definition may be provided whereby Λ(Ψ)is a tight wavelet frame if it is a frame with A=B. In this case, after a renormalization of the g's in Ψ, the following equation is derived:

$${\sum }_{g ∈ Λ ( Ψ )}^{ } {⌊ 〈 f , g 〉 ⌋}^{2} = {‖ f ‖}_{{L}_{2} ( {ℛ}^{2} )}^{2} \qquad ( Eq . 4 )$$

for all fεL₂(R²). It is known that when Λ(Ψ) is a tight wavelet frame, any fεL₂(R²) can be recovered from gεΛΨ. In other words, the sum of the squares of coefficients in the expansion of an image in terms of functions in a frame (c.f., Eq. 5) is the same as the square of the energy of the image. Accordingly, the following equation results:

$$f = {\sum }_{g ∈ Λ ( Ψ )}^{ } 〈 f , g 〉 g , ∀ f ∈ {L}_{2} ( {ℛ}^{2} ) . \qquad ( Eq . 5 )$$

Let φεL₂(R²) be a compactly supported refinable function. That is,

\hat{φ}(ω)=P(ω/2)\hat{φ}(ω/2), (Eq. 6)

where P(ω) is a trigonometric polynomial in e^{iω}. P is often called a mask of refinable function φ. Accordingly, Qᵢ's (trigonometric polynomial) are determined such that

$$P ( ω ) \overline{P ( ω + λ )} + {\sum }_{i = 0}^{r} {Q}_{i} ( ω ) \overline{{Q}_{i} ( ω + λ )} = \{ \begin{matrix}1 , if λ = 0 , \\ 0 , λ ∈ {\{ 0 , 1 \}}^{2} π \backslash \{ 0 \} .\end{matrix} \qquad ( Eq . 7 )$$

The conditions referenced in equation (7) are recognized by those having ordinary skill in the art as the Unitary Extension Principle (UEP). With these Qᵢ's, wavelet frame generators or framelets, ψ⁽ⁱ⁾ can be determined. Such framelets can be defined in terms of a Fourier transform by the following equation:

\hat{ψ}⁽ⁱ⁾(ω)=Qᵢ(ω/2)\hat{φ}(ω/2), i=1, . . . , r. (Eq. 8)

Then, if φ belongs to Lip α with α>0, Ψ={ψ⁽ⁱ⁾,i=1, . . ., r} generates a tight wavelet frame (i.e., Λ(Ψ) is a tight wavelet frame).

Furthermore, letting Q be a rectangular matrix defined by the following equation:

$$Q = [ \begin{matrix}{Q}_{1} ( ξ , η ) & {Q}_{1} ( ξ + π , η ) & {Q}_{1} ( ξ , η + π ) & {Q}_{1} ( ξ + π , η + π ) \\ {Q}_{2} ( ξ , η ) & {Q}_{2} ( ξ + π , η ) & {Q}_{2} ( ξ , η + π ) & {Q}_{2} ( ξ + π , η + π ) \\ {Q}_{3} ( ξ , η ) & {Q}_{3} ( ξ + π , η ) & {Q}_{3} ( ξ , η + π ) & {Q}_{3} ( ξ + π , η + π ) \\ {Q}_{4} ( ξ , η ) & {Q}_{4} ( ξ + π , η ) & {Q}_{4} ( ξ , η + π ) & {Q}_{4} ( ξ + π , η + π )\end{matrix} ] , \qquad ( Eq . 9 )$$

and P=(P(ξ,η),P(ξ+π,η),P(ε,η+π),P(ε+π,η+π))^{T}, equation (7) becomes the following equation:

Q*Q=I_{4×4}− P̅P^{T}. (Eq. 10)

The construction of tight wavelet frames involves finding a Q that satisfies equation (10). It is well-known that Q can be easily found if P satisfies the quadrature mirror filter (QMF) condition (i.e., P^{T}P=1).

Next, an observation is made that the mask P of many refinable functions φ satisfies the following sub-QMF condition:

$${\sum }_{λ ∈ {\{ 0 , 1 \}}^{2} π}^{ } {\vert P ( ω + λ ) \vert}^{2} \leq 1. \qquad ( Eq . 11 )$$

In particular, for box-splines on a three or four direction mesh, the mask P will satisfy equation (11). The following well-known theorem can now be used to construct framelets (i.e., generating functions): suppose that P satisfies the sub-QMF condition of equation (11). Also, suppose that there exists Laurent polynomials \tilde{P}₁, K, \tilde{P}_{N} such that

$${\sum }_{m ∈ {\{ 0 , 1 \}}^{2}}^{ } {\vert {P}_{m} ( ω ) \vert}^{2} + {\sum }_{i = 1}^{N} {\vert \tilde{{P}_{i}} ( ω ) \vert}^{2} = 1. \qquad ( Eq . 12 )$$

Then there exists 4+N compactly supported framelets with wavelet masks Qₘ, m=1,K, 4+N such that P, Qₘ, m=1,K, 4+N satisfy equation (10). Note that the proof of the above theorem is constructive. That is, the proof provides a method to construct tight wavelet frames. In contrast, a proof can be non-constructive in the sense that the existence of tight wavelet frames is shown without showing how to construct them. Thus, the method in the proof leads to the construction of Qₘ, and hence, framelets ψ^{(m)}, m=1,Λ,4+N . Box-splines can be to illustrate how to construct ψ^{(m)}′S.

Considering now the definition of box-spline functions on four direction mesh, set e₁=(1,0), e₂=(0,1), e₃=e₁+e₂, e₄=e₁−e₂ to be direction vectors and let D be a set of these vectors with some repetitions. The box-spline φ_{D} associated with direction set D may be defined in terms of refinable equation by the following equation:

$${\hat{φ}}_{D} ( ω ) = {P}_{D} ( \frac{ω}{2} ) {\hat{φ}}_{D} ( \frac{ω}{2} ) , \qquad ( Eq . 13 )$$

where P_{D} is the mask associated with φ defined by the following equation:

$${P}_{D} ( ω ) = {\prod }_{ξ ∈ D}^{ } \frac{1 + {e}^{- i ξ \cdot ω}}{2} . \qquad ( Eq . 14 )$$

Note that the mask P_{D} satisfies equation (11). Using the above-mentioned constructive method, Qₘ and their associated framelets ψₘ for many box-spline functions on three and four direction meshes can be constructed. Framelets based on box-spline φ₂₂₁₁ are demonstrated, with the understanding that other box-splines and/or other types may be used.

For box-spline φ₂₂₁₁ with D={e₁, e₁, e₂, e₂, e₃, e₄}, the following equation is provided:

$${P}_{2211} ( ω ) = {( \frac{1 + {e}^{- i {ω}_{1}}}{2} )}^{2} {( \frac{1 + {e}^{- i {ω}_{2}}}{2} )}^{2} ( \frac{1 + {e}^{- i ( {ω}_{1} + {ω}_{2} ) }}{2} ) ( \frac{1 + {e}^{- i ( {ω}_{1} + {ω}_{2} )}}{2} ) . \qquad ( Eq . 15 )$$

It is straightforward to confirm the following equations:

$$\begin{matrix}1 - {\sum }_{λ ∈ {\{ 0 , 1 \}}^{2} π}^{ } {\vert {P}_{2211} ( ω + λ ) \vert}^{2} = {\sum }_{i = 1}^{4} {\vert \tilde{{P}_{i}} ( ω ) \vert}^{2} , \\ where & ( Eq . 16 ) \\ {\tilde{P}}_{i} ( ω ) = \frac{\sqrt{1886}}{224} ( 1 - {e}^{4 i {ω}_{1}} ) , & ( Eq . 17 ) \\ {\tilde{P}}_{2} ( ω ) = \frac{3 \sqrt{14}}{64} + \frac{\sqrt{40531922}}{25472} + \frac{3 \sqrt{14}}{32} {e}^{2 i {ω}_{2}} - ( \frac{3 \sqrt{14}}{64} + \frac{\sqrt{40531922}}{25472} ) {e}^{4 i {ω}_{2}} & ( Eq . 18 ) \\ {\tilde{P}}_{3} ( ω ) = \frac{7 \sqrt{2}}{64} + \frac{7 \sqrt{2}}{64} {e}^{4 i {ω}_{2}} - \frac{\sqrt{2}}{224} {e}^{i ( 4 {ω}_{1} + 2 {ω}_{2} )} - \frac{3 \sqrt{2}}{14} {e}^{2 i ( {ω}_{i} + {ω}_{2} ) ,} & ( Eq . 19 ) \\ {\tilde{P}}_{4} ( ω ) = \frac{\sqrt{398}}{112} + \frac{\sqrt{398}}{112} {e}^{4 i {ω}_{1}} - \frac{3135 \sqrt{398}}{178304} {e}^{2 {iω}_{i}} - \frac{7 \sqrt{398}}{25472} {e}^{i ( 2 {ω}_{i} + 4 {ω}_{2} )} . & ( Eq . 20 )\end{matrix}$$

Hence, eight (8) tight frame generators or framelets using the constructive steps in the proof of the above theorem are generated. These eight (8) framelets ψₘ can be expressed in terms of a Fourier transform by the following equation:

\hat{ψ}ₘ(ω)=Qₘ(ω/2)\hat{φ}₂₂₁₁(ω/2), (Eq. 21)

where Qₘ, m=1, Λ, 8 are given in terms of coefficient matrices as follows:

$${Q}_{1} = {\sum }_{j = 0}^{8} {\sum }_{k - 0}^{6} {c}_{jk} {e}^{- i j \overline{ω}} {e}^{- i k ξ} {with \\ [ {c}_{jk} ]}_{\frac{0 \leq j \leq 8}{0 \leq k \leq 6}} = \frac{- 1}{2048} [ \begin{matrix}0 & 1 & 2 & 2 & 2 & 1 & 0 \\ 1 & 4 & 7 & 8 & 7 & 4 & 1 \\ 2 & 12 & 22 & 24 & 22 & 12 & 2 \\ 7 & 28 & 49 & 56 & 49 & 28 & 7 \\ 12 & 38 & 64 & - 948 & 64 & 38 & 12 \\ 7 & 28 & 49 & 56 & 49 & 28 & 7 \\ 2 & 12 & 22 & 24 & 22 & 12 & 2 \\ 1 & 4 & 7 & 8 & 7 & 4 & 1 \\ 0 & 1 & 2 & 2 & 2 & 1 & 0\end{matrix} ] , \\ {Q}_{2} = {\sum }_{j = 0}^{6} {\sum }_{k = 0}^{6} {C}_{jk} {e}^{- i j ω} {e}^{- i k ξ} {with [ {c}_{jk} ]}_{\frac{0 \leq j \leq 6}{0 \leq k \leq 6}} = \frac{- 1}{512} [ \begin{matrix}0 & 1 & 2 & 2 & 2 & 1 & 0 \\ 1 & 4 & 7 & 8 & 7 & 4 & 1 \\ 2 & 7 & 12 & 14 & 12 & 7 & 2 \\ 2 & 8 & 14 & - 240 & 14 & 8 & 2 \\ 2 & 7 & 12 & 14 & 12 & 7 & 2 \\ 1 & 4 & 7 & 8 & 7 & 4 & 1 \\ 0 & 1 & 2 & 2 & 2 & 1 & 0\end{matrix} ] , \\ {Q}_{3} = {\sum }_{j = 0}^{8} {\sum }_{k = 0}^{8} {C}_{jk} {e}^{- i j ω} {e}^{- i k ξ} {with \\ [ {c}_{jk} ]}_{\frac{0 \leq j \leq 8}{0 \leq k \leq 8}} = \frac{- 1}{1024} [ \begin{matrix}0 & 0 & 0 & 1 & 2 & 1 & 0 & 0 & 0 \\ 0 & 0 & 1 & 4 & 6 & 4 & 1 & 0 & 0 \\ 0 & 1 & 4 & 11 & 16 & 11 & 4 & 1 & 0 \\ 1 & 4 & 11 & 24 & 32 & 24 & 11 & 4 & 1 \\ 2 & 6 & 16 & 32 & - 472 & 32 & 16 & 6 & 2 \\ 1 & 4 & 11 & 24 & 32 & 24 & 11 & 4 & 1 \\ 0 & 1 & 4 & 11 & 16 & 11 & 4 & 1 & 0 \\ 0 & 0 & 1 & 4 & 6 & 4 & 1 & 0 & 0 \\ 0 & 0 & 0 & 1 & 2 & 1 & 0 & 0 & 0\end{matrix} ] , \\ {Q}_{4} = {\sum }_{j = 0}^{6} {\sum }_{k = 0}^{8} {C}_{jk} {e}^{- i j ω} {e}^{- i k ξ} {with \\ [ {c}_{jk} ]}_{\frac{0 \leq j \leq 6}{0 \leq k \leq 8}} = \frac{- 1}{2048} [ \begin{matrix}0 & 1 & 2 & 7 & 12 & 7 & 2 & 1 & 0 \\ 1 & 4 & 12 & 28 & 39 & 28 & 12 & 4 & 1 \\ 2 & 7 & 22 & 49 & 64 & 49 & 22 & 7 & 2 \\ 2 & 8 & 24 & 56 & - 948 & 56 & 24 & 8 & 2 \\ 2 & 7 & 22 & 49 & 64 & 49 & 22 & 7 & 2 \\ 1 & 4 & 12 & 28 & 38 & 28 & 12 & 4 & 1 \\ 0 & 1 & 2 & 7 & 12 & 7 & 2 & 1 & 0\end{matrix} ] , \\ {Q}_{5} = {\sum }_{j = 0}^{8} {\sum }_{k = 0}^{8} {C}_{jk} {e}^{- i j ω} {e}^{- i k ξ} {with \\ [ {c}_{jk} ]}_{\frac{0 \leq j \leq 8}{0 \leq k \leq 8}} = \frac{- \sqrt{2}}{28672} [ \begin{matrix}0 & 49 & 98 & 49 & 0 & 49 & 98 & 49 & 0 \\ 49 & 196 & 294 & 196 & 98 & 196 & 294 & 196 & 49 \\ 98 & 294 & 392 & 198 & 4 & 198 & 392 & 294 & 98 \\ 49 & 196 & 198 & - 188 & - 478 & - 188 & 198 & 196 & 49 \\ 0 & 49 & - 94 & - 529 & - 772 & - 529 & - 94 & 49 & 0 \\ 0 & 0 & - 98 & - 392 & - 588 & - 392 & - 98 & 0 & 0 \\ 0 & 0 & - 4 & - 108 & - 208 & - 108 & - 4 & 0 & 0 \\ 0 & 0 & - 2 & - 8 & - 12 & - 8 & - 2 & 0 & 0 \\ 0 & 0 & 0 & - 2 & - 4 & - 2 & 0 & 0 & 0\end{matrix} ] , \\ {Q}_{6} = {\sum }_{j = 0}^{8} {\sum }_{k = 0}^{8} {C}_{jk} {e}^{- i j ω } {e}^{- i k ξ} {with \\ [ {c}_{jk} ]}_{\frac{0 \leq j \leq 8}{0 \leq k \leq 8}} = \frac{- \sqrt{398}}{11411456} [ \begin{matrix}0 & 1592 & 3184 & 1592 & 0 & 0 & 0 & 0 & 0 \\ 1592 & 6368 & 9552 & 6368 & 1592 & 0 & 0 & 0 & 0 \\ 3184 & 6417 & 6466 & 6417 & 3184 & - 49 & - 98 & - 49 & 0 \\ - 1543 & - 6172 & - 9258 & - 6172 & - 1592 & - 196 & - 294 & - 196 & - 49 \\ - 6270 & - 15626 & - 18712 & - 15626 & - 6368 & - 294 & - 392 & - 294 & - 98 \\ - 1543 & - 6172 & - 9258 & - 6172 & - 1592 & - 196 & - 294 & - 196 & - 49 \\ 3184 & 6417 & 6466 & 6417 & 3184 & - 49 & - 98 & - 49 & 0 \\ 1592 & 6368 & 9552 & 6368 & 1592 & 0 & 0 & 0 & 0 \\ 0 & 1592 & 3184 & 1592 & 0 & 0 & 0 & 0 & 0\end{matrix} ] , \\ {Q}_{7} {\sum }_{j = 0}^{4} {\sum }_{k = 0}^{8} {C}_{jk} {e}^{- i j ω } {e}^{- i k ξ} {with \\ [ {c}_{jk} ]}_{\frac{0 \leq j \leq 4}{0 \leq k \leq 4}} = \sqrt{2 \times } [ \begin{matrix}0 & - 47 / 57062 & - 47 / 28531 & - 149 / 31707 & - 84 / 10837 \\ - 47 / 57062 & - 94 / 28531 & - 127 / 14403 & - 596 / 31707 & - 253 / 13056 \\ - 47 / 28531 & - 141 / 28531 & - 71 / 4951 & - 298 / 10569 & - 253 / 10880 \\ - 47 / 57062 & - 94 / 28531 & - 127 / 14403 & - 596 / 31707 & - 253 / 13056 \\ 0 & - 47 / 57062 & - 47 / 28531 & - 149 / 31707 & - 84 / 10837\end{matrix} ] , \\ {and \\ [ {c}_{jk} ]}_{\frac{0 \leq j \leq 4}{5 \leq k \leq 8}} = \sqrt{2} [ \begin{matrix}47 / 57062 & 298 / 31707 & 149 / 31707 & 0 \\ 94 / 28531 & 169 / 6949 & 596 / 31707 & 149 / 31707 \\ 141 / 28531 & 230 / 7707 & 298 / 10569 & 298 / 31707 \\ 94 / 28531 & 169 / 6949 & 596 / 31707 & 149 / 31707 \\ 47 / 57062 & 169 / 31707 & 149 / 31707 & 0\end{matrix} ] , \\ and finally {Q}_{8} = {\sum }_{j = 0}^{8} {\sum }_{k = 0}^{5} {C}_{jk} {e}^{- i j ω} {e}^{- i k ξ} {with \\ [ {c}_{jk} ]}_{\frac{0 \leq j \leq 8}{0 \leq k \leq 5}} = \frac{- \sqrt{1886}}{14336} [ \begin{matrix}0 & 1 & 2 & 1 & 0 \\ 1 & 4 & 6 & 4 & 1 \\ 2 & 6 & 8 & 6 & 2 \\ 1 & 4 & 6 & 4 & 1 \\ 0 & 0 & 0 & 0 & 0 \\ - 1 & - 4 & - 6 & - 4 & - 1 \\ - 2 & - 6 & - 8 & - 6 & - 2 \\ - 1 & - 4 & - 6 & - 4 & - 1 \\ 0 & - 1 & - 2 & - 1 & 0\end{matrix} ] ,$$

These coefficient matrices are high-pass filters associated with low-pass filter P₂₂₁₁. Such coefficient matrices satisfy equation (10), which is an exact reconstruction condition. Note that P₂₂₁₁ is associated with B₂₂₁₁ using Eq. (13). Further note that when P₂₂₁₁ is expressed in the form of

$${P}_{2211} = {\sum }_{j = 0}^{4} {\sum }_{k = 0}^{4} {p}_{jk} {e}^{- i j ω} {e}^{- i k ξ} ,$$

[pⱼₖ] is a coefficient matrix of low-pass filter.

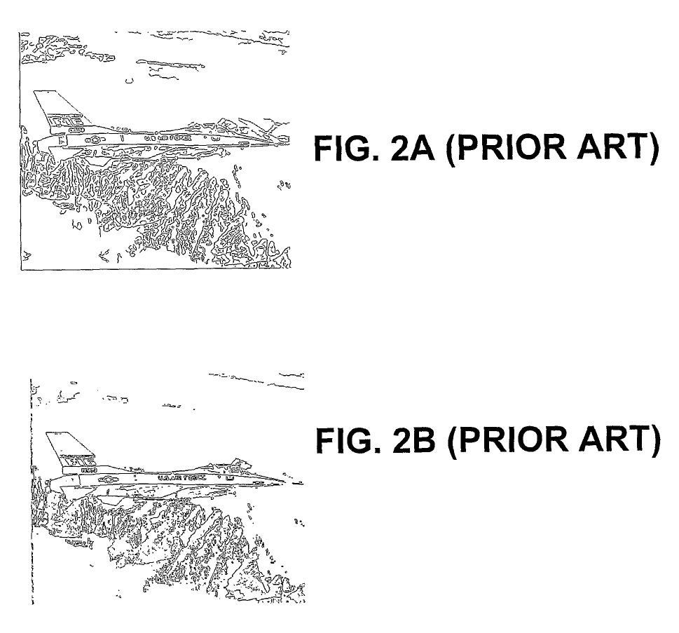

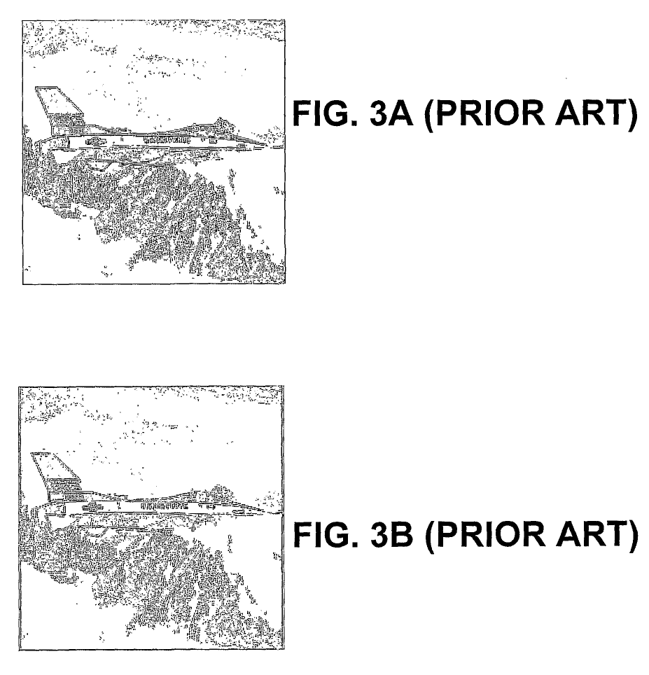

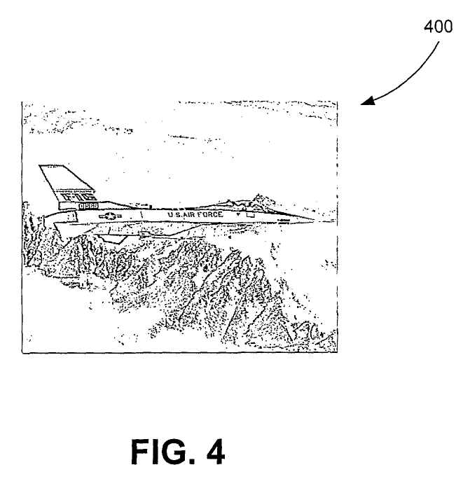

The tight wavelet frames based on box-spline B₂₂₁₁ for edge detection have been applied experimentally to provide the results shown in FIG. 4. In particular, FIG. 4 illustrates an edge detection image 400 using an edge detection method embodiment, and in particular, the application of the above-described tight wavelet frame based on box-spline function B₂₂₁₁. As shown, the edges and features from the image 400 (F-16 fighter jet) are easily discernible (e.g., the letters U.S. AIR FORCE are well recognizable). Comparing with the Canny and Sobel methods described above in association with FIGS. 2A and 2B, or the wavelet method illustrated in FIGS. 3A and 3B, it is clear that the image edge detection methods of the preferred embodiments provides for better detection of these letters and other features.

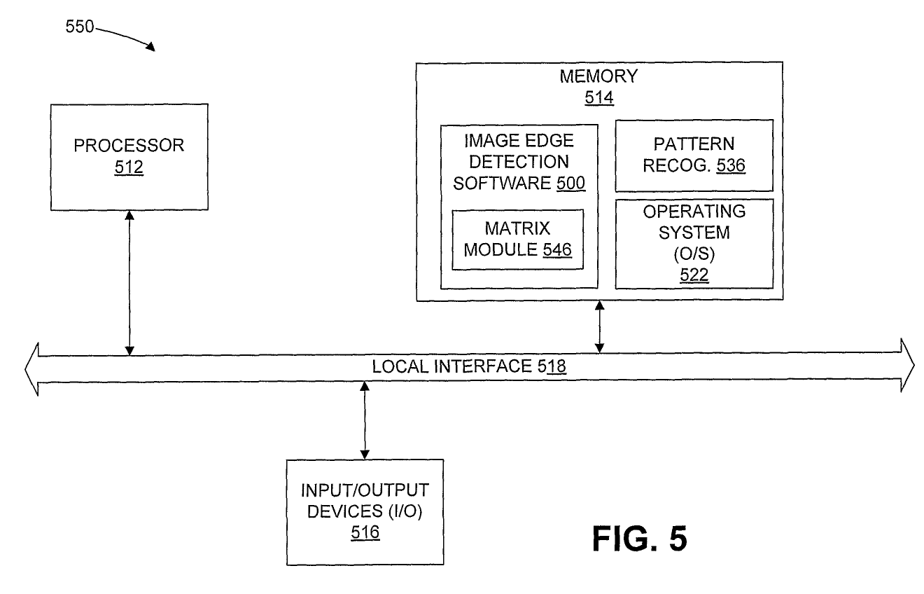

Having described the derivation of an exemplary tight wavelet frame based on an exemplary box-spline and results of the application of the same for edge detection functionality, an embodiment of an edge detection system based on the derivation described above is shown in FIG. 5. In particular, FIG. 5 is a block diagram showing a configuration of an image edge detection system 550 that incorporates image edge detection software. In FIG. 5, image edge detection software is denoted by reference numeral 500. Note that in some embodiments, an image edge detection system may incorporate one or more additional elements not shown in FIG. 5 or fewer elements than those shown in FIG. 5, or in some embodiments, may be embodied in an application specific integrated circuit (ASIC) or other processing device. Generally, in terms of hardware architecture, the image edge detection system 550 includes a processor 512, memory 514, and one or more input and/or output (I/O) devices 516 (or peripherals) that are communicatively coupled via a local interface 518. The local interface 518 may be, for example, one or more buses or other wired or wireless connections. The local interface 518 may have additional elements such as controllers, buffers (caches), drivers, repeaters, and receivers, to enable communication. Further, the local interface 518 may include address, control, and/or data connections that enable appropriate communication among the aforementioned components.

The processor 512 is a hardware device for executing software, particularly that which is stored in memory 514. The processor 512 may be any custom made or commercially available processor, a central processing unit (CPU), an auxiliary processor among several processors associated with the image edge detection system 550, a semiconductor-based microprocessor (in the form of a microchip or chip set), a macroprocessor, or generally any device for executing software instructions.

The memory 514 may include any one or combination of volatile memory elements (e.g., random access memory (RAM)) and nonvolatile memory elements (e.g., ROM, hard drive, etc.). Moreover, the memory 514 may incorporate electronic, magnetic, optical, and/or other types of storage media. Note that the memory 514 may have a distributed architecture in which various components are situated remotely from one another but may be accessed by the processor 512.

The software in memory 514 may include one or more separate programs, each of which comprises an ordered listing of executable instructions for implementing logical functions. In the example of FIG. 5, the software in the memory 514 includes the image edge detection software 500 according to an embodiment, known pattern recognition software 536, and a suitable operating system (O/S) 522. In some embodiments, functionality of the pattern recognition software 536 may be incorporated into the image edge detection software 500. The operating system 522 essentially controls the execution of other computer programs, such as the image edge detection software 500 and/or the pattern recognition software 536, and provides scheduling, input-output control, file and data management, memory management, and communication control and related services.

The image edge detection software 500 is a source program, executable program (object code), script, or any other entity comprising a set of instructions to be performed. The image edge detection software 500 can be implemented, in one embodiment, as a distributed network of modules, where one or more of the modules can be accessed by one or more applications or programs or components thereof.

For instance, one module of the image edge detection software 500 comprises a matrix module 546. The matrix module 546 comprises P₂₂₁₁ used as a low-pass filter, and/or the matrices Q₁ through Q8 used as high pass filters in the derivation of an image comprising detectable edges (such as that shown in FIG. 4). The matrices may be formatted according to one of several known data structure mechanisms. In some embodiments, the image edge detection software 500 can be implemented as a single module with all of the functionality of the aforementioned modules. When the image edge detection software 500 is a source program, then the program is translated via a compiler, assembler, interpreter, or the like, which may or may not be included within the memory 514, so as to operate properly in connection with the O/S 522. Furthermore, the image edge detection software 500 can be written with (a) an object oriented programming language, which has classes of data and methods, or (b) a procedure programming language, which has routines, subroutines, and/or functions, for example but not limited to, C, C++, Pascal, Basic, Fortran, Cobol, Perl, Java, and Ada.

The I/O devices 516 may include input devices such as, for example, a keyboard, mouse, scanner, microphone, etc. Furthermore, the I/O devices 516 may also include output devices such as, for example, a printer, display, etc. Finally, the I/O devices 516 may further include devices that communicate both inputs and outputs such as, for instance, a modulator/demodulator (modem for accessing another device, system, or network), a radio frequency (RF) or other transceiver, a telephonic interface, a bridge, a router, etc.

When the image edge detection system 550 is in operation, the processor 512 is configured to execute software stored within the memory 514, to communicate data to and from the memory 514, and to generally control operations of the image edge detection system 550 pursuant to the software. The image edge detection software 500, pattern recognition software 534, and the O/S 522, in whole or in part, but typically the latter, are read by the processor 512, buffered within the processor 512, and then executed.

When the image edge detection system 550 is implemented all or primarily in software, as is shown in FIG. 5, it should be noted that the image edge detection software 500 can be stored on any computer-readable medium for use by or in connection with any computer-related system or method. In the context of this document, a computer-readable medium is an electronic, magnetic, optical, or other physical device or means that can contain or store a computer program for use by or in connection with a computer related system or method. The image edge detection system 500 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In an alternative embodiment, where the image edge detection system 550 (including functionality of the image edge detection software 500) is implemented in hardware, the image edge detection system 550 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc; or can be implemented with other technologies now known or later developed.

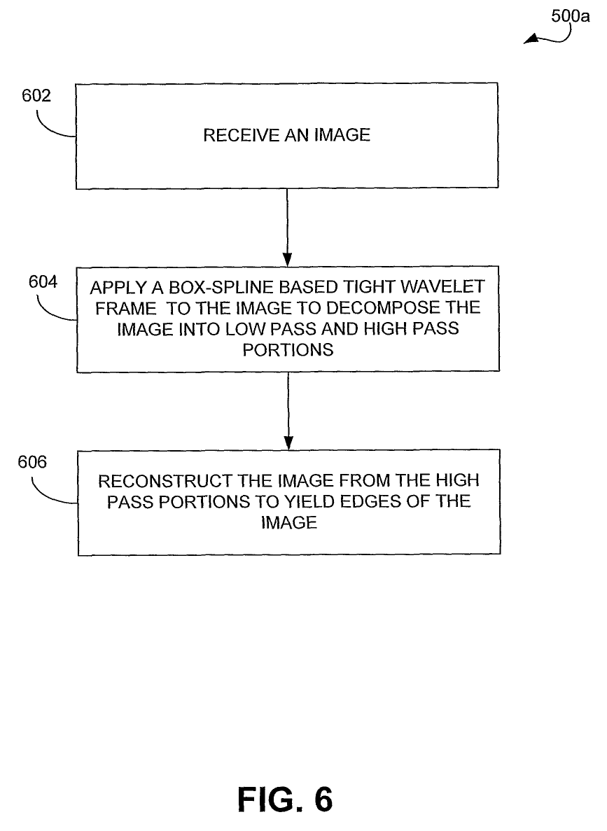

FIG. 6 provides a flow diagram of a method embodiment of the image edge detection software 500. The method, designated as method 500a, comprises receiving an image (602), and applying a box-spline based, tight wavelet frame to the image to decompose the image into a plurality of subimages that comprise a low-pass part or portion and several high-pass parts or portions of the image (604). As described above, the tight wavelet frame comprises a plurality of framelets acting as high-pass filters. For instance, with continued reference to FIGS. 5 and 6, the image edge detection software 500 receives an image in the form of image data. The image edge detection software 500 applies (e.g., combines) the image data to elements of the matrix module 546, the elements comprising coefficient matrices corresponding to framelets Q1 through QS (high-pass filters) and a coefficient matrix P₂₂₁₁ (low-pass filter). That is, the image data is low-pass and high-pass filtered using P₂₂₁₁ and the framelets Q1 through Q8, respectively, to provide sub-images comprising low-pass parts and high-pass parts. The coefficient matrices are based on one or more box-spline tight wavelet frames, as described by the derivation described above.

Block (606) comprises reconstructing the image from the high pass portions to yield edges of the image. For example, the matrix corresponding to the low-pass part is set to zero and the matrices that produce the high-pass parts are used to reconstruct the image. The reconstructed image comprises the edges of the image (e.g., the image 400 shown in FIG. 4).

Further processing may optionally be employed, such as providing the edge detected image (e.g., 400) to the pattern recognition software 534 to enable recognition of objects within the image, such as words, labels, among other objects.

For box-spline tight wavelet frames, only one level of decomposition typically needs to be performed, compared to a plurality of decompositions for standard wavelets (e.g., Haar, D4, D6, biothogonal 9/7 wavelets). However, depending on the image, more levels of decomposition may be required. For instance, some images, such as a finger print image, may require more levels (e.g., three) of decomposition.

In some embodiments, to present the edges more clearly, the reconstructed image is optionally normalized into a standard grey level ranging between 0 and 255, and a predefined threshold is used to divide the pixel values into two major groups. That is, if a pixel value is bigger than the threshold, it is set to be 1. Otherwise, the pixel value is set to zero. Such functionality may be provided by the image edge detection software 500 or other modules or devices.

Also, in some embodiments, one or more of the reconstructed edges may optionally be treated for isolated dots (i.e., one or more isolated nonzero pixel values are removed). Such functionality may be provided by the image edge detection software 500 or other modules or devices.

Any process descriptions should be understood as representing steps in a process, and alternate implementations are included within the scope of the disclosure, in which steps may be executed out of the order described, including substantially concurrently or in reverse order, as would be understood by those reasonably skilled in the art. Further, other systems, methods, features, and advantages of the disclosure will be or become apparent to one with skill in the art upon examination of the drawings and detailed description.

It should be emphasized that the above-described embodiments, particularly, any “preferred” embodiments, are merely possible examples of implementations, merely set forth for a clear understanding of the principles of the disclosure. Many variations and modifications may be made to the above-described embodiments without departing substantially in spirit and scope. All such modifications and variations are intended to be included herein within the scope of this disclosure.

What is claimed:

1. An image edge detection system (550), comprising:
memory (514) with image edge detection software (500);
a processor (512) configured with the image edge detection software to receive an image (100), apply a box-spline based tight wavelet frame to the image to decompose the image into low pass and high pass portions, and reconstruct the image from the high pass portions to yield edges of the image.

2. The system of claim 1, wherein the box-spline based tight wavelet frame comprises a low pass filter.

3. The system of claim 1, wherein the box-spline based tight wavelet frame comprises one or more framelets corresponding to high-pass filter functionality.

4. The system of claim 1, wherein the image edge detection software comprises a matrix module (546) comprising the box-spline based tight wavelet frame.

5. The system of claim 1, wherein the memory further comprises pattern recognition software (536).

6. The system of claim 5, wherein the processor is further configured with the pattern recognition software to receive the edges and enable recognition of objects in the reconstructed image (400) based on the edges.

7. The system of claim 1, wherein the processor is further configured with the image edge detection software to normalize the reconstructed image into standard gray levels.

8. The system of claim 1, wherein the processor is further configured with the image edge detection software to impose thresholds to pixel values corresponding to the reconstructed image.

9. The system of claim 1, wherein the processor is further configured with the image edge detection software to remove isolated dots from the reconstructed image.

10. An image edge detection method (500a), comprising:
receiving an image (602);
applying a box-spline based tight wavelet frame to the image to decompose the image into low pass and high pass portions (604); and
reconstructing the image from the high pass portions to yield edges of the image (606).

11. The method of claim 10, wherein applying comprises multiplying framelets corresponding to the tight wavelet frame and a low-pass filter with image data corresponding to the image.

12. The method of claim 10, wherein reconstructing comprises setting a matrix corresponding to the low-pass portion of a decomposed image to zero.

13. The method of claim 10, further comprising receiving the edges and enabling recognition of objects in the reconstructed image.

14. The method of claim 10, farther comprising normalizing the reconstructed image into standard gray levels.

15. The method of claim 14, wherein normalizing comprises imposing thresholds to pixel values corresponding to the reconstructed image.

16. The method of claim 10, further comprising removing isolated dots from the reconstructed image.

17. A computer-readable medium having a computer program for detecting edges in an image, the computer-readable medium comprising:
logic configured to receive an image (500);
logic configured to apply a box-spline based tight wavelet frame to the image to decompose the image into low pass and high pass portions (500, 546); and
logic configured to reconstruct the image from the high pass portions to yield edges of the image (500).

18. The computer-readable medium of claim 17, further comprising logic (536) configured to provide pattern recognition.

19. The computer-readable medium of claim 17, further comprising logic configured to normalize the reconstructed image into standard gray levels.

20. The computer-readable medium of claim 17, further comprising logic configured to remove isolated dots from the reconstructed image.

21. An image edge detection system (550), comprising:
means for receiving an image (500);
means for applying a box-spline based tight wavelet frame to the image to decompose the image into low pass and high pass portions (500, 546); and
means for reconstructing the image from the high pass portions to yield edges of the image (500).

22. The system of claim 21, wherein the means for receiving, applying, and reconstructing comprise software, hardware, or a combination of software and hardware.
